(19) United States
(12) Patent Application Publication
(10) Pub. No.: US 2008/0035660 A1
(43) Pub. Date: Feb. 14, 2008

(54) MEDICINE DISPENSING SYSTEM

(76) Inventor: Paul E. Dow, Bethlehem, PA (US)

Correspondence Address: LAW OFFICES OF DONALD COX, P.O. BOX 505, PRINCETON, NJ, 08542-0505, US

(21) Appl. No.: 11/464,193

(22) Filed: Aug. 12, 2006

(51) Int. Cl. G07F 11/00

(52) U.S. Cl. 221/4

(57) ABSTRACT

A medicine dispensing apparatus is described including at least one module having a plurality of compartments. At least one side of the module has apertures to the compartments arranged in an array of rows and columns. The module includes an engagement track extending along columns of compartments. A compartment cover releasably inserted into the engagement track covers a column of compartments.

### BACKGROUND OF THE INVENTION

1. Field of the Invention

This invention relates generally to medication dispensing systems, and, more particularly, to medication dispensing systems to facilitate the timely taking of medicine.

2. Description of the Related Art

The dispensing of medication to ensure that dosing of medication follows a prescribed protocol remains a task that is largely left to the individual patient or patient's caretaker to ensure medication is taken properly. Improper dosing of medications can result delayed recovery for the patient if under utilized or in serious side effects if over utilized. The problem with effective dosing is even more acute with the elder as they often forget to take certain medications or fail to take the prescribed amount.

Often such medicine dispensing devices are difficult to use and can take up much space. Furthermore patients may easily get confused as which dosage to take next. Thus the need exists for a way for patients to determine where the next dosage is to come from.

A number of medication dispensing systems and devices have been developed, however such systems have proven to be costly to manufacture or difficult to use and maintain. Furthermore, medical profession resulting in more specializations as well as changes in the distribution of prescription drugs has resulted in the need for patients to track prescriptions as they relate to different doctors and pharmacies. Thus, today a patient not only needs to know that a prescription must be refilled, but the patient must know the doctor that wrote the prescription and the pharmacy that dispenses that drug. With the advent of additional on-line prescription services, patients have more selection in choosing the best price as well as the best choice for filling a prescription. Keeping track of all this information can add to the patient's confusion over where and when to get the prescription filled next.

Thus, the need exists for a way to provide a medicine dispensing apparatus that is easy to use, simple to operate and accommodates patients needs in an age of information overload.

### SUMMARY OF THE INVENTION

A medicine dispensing apparatus is described including at least one module having a plurality of compartments. At least one side of the module has apertures to the compartments arranged in an array of rows and columns. The module includes an engagement track extending along columns of compartments. A compartment cover releasably inserted into the engagement track covers a column of compartments.

In another embodiment, a medicine dispensing apparatus includes at least one module including a plurality of compartments. The opposing sides of the module have apertures to the compartments arranged in an array of rows and columns. Each opposing side of the module includes a set of compartments that is independent from the other opposing side. Each compartment has a volume formed from a gradually tapered cross-sectional area of the compartment that extends from a greatest cross-sectional area at the opening to a least cross-sectional area most distant from the aperture.

In yet another embodiment, a medicine dispensing apparatus includes at least one module having a plurality of medication compartments, a compartment for storing prescription information, and a medicine information device operating under the control of software. The medicine information device provides reminders of medication dosing times, reminders of doctor's appointments, reminders of prescription renewals and a cross-indexed reference tying medication and prescription information to the issuing doctor and pharmacy. Thus, the medicine dispensing apparatus provides a convenient way for users to organize, dispense and refill medication dosages.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is a perspective view of a medicine dispensing apparatus according to the present invention;

FIG. 2 is a perspective view of a compartment cover according to the present invention;

FIG. 3 is a top plan view of the compartment cover according to FIG. 2;

FIG. 4A is a cut-away perspective view of FIG. 1 of a compartment cover in a locked position relative to a module column

FIG. 4B is a cut-away perspective view of FIG. 1 of a compartment cover in an unlocked position relative to a module column;

FIG. 5 is a perspective view of a medicine dispensing apparatus having two modules and compartment covers in differing positions;

FIG. 6 is a front perspective view of a module of a medicine dispensing apparatus;

FIG. 7 is an inverted rear perspective view of the module of FIG. 6;

FIG. 8 is a perspective view of alternative medicine dispensing apparatus according to the present invention;

FIG. 9 is a perspective view of an alternate embodiment of a module of a medicine dispensing apparatus according to the present invention;

FIG. 10 is a block diagram of a medicine information device for a medical dispensing apparatus according to the present invention; and

FIG. 11 is a perspective view of a dispensing cup according to the present invention.

### DETAILED DESCRIPTION

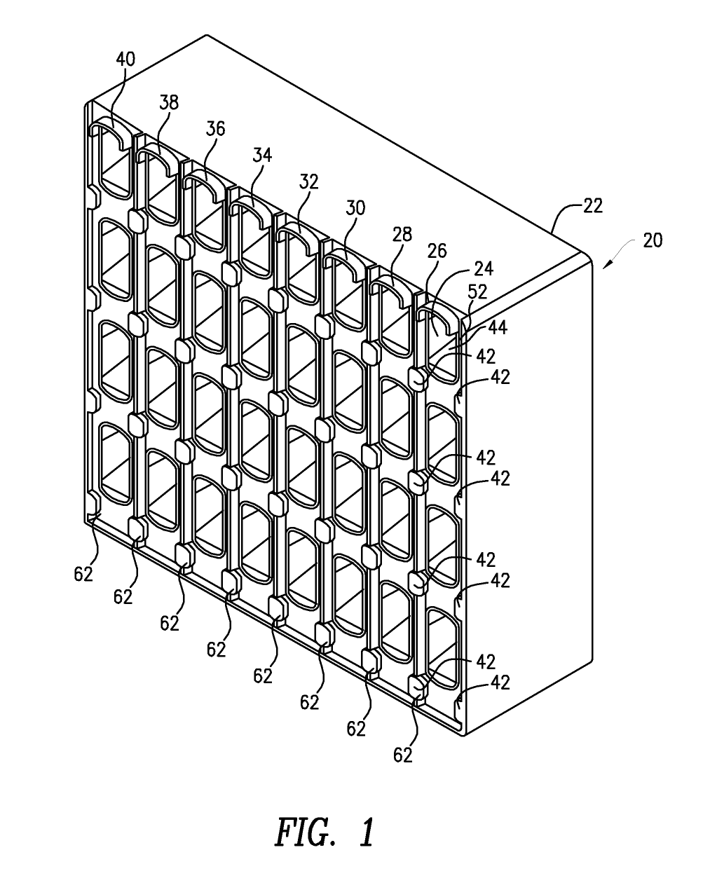

With reference to the drawings for purposes of illustration, a medicine dispensing apparatus 20 (FIG. 1) having a module 22 formed with a plurality of medicine compartments 24 formed into an array of rows and columns along at least one side of the module. As presently show in one preferred embodiment, there are 32 compartments on one side of the module formed by eight columns with four rows each. Each column of compartments 24 is covered by a compartment cover 26, 28, 30, 32, 34, 36, 38 and 40 that is advantageously slideable along the respective column to open and cover different compartments within the module along a track formed between the compartment cover 26 and engagement points 42 positioned along the sides of the column. When aligned for dispensing medicine, each compartment 24 includes an inclined or sloped floor 44 that directs medicine towards the opening of the compartment. As the compartment cover is slid relative to the module to reveal another compartment, the sloped surface of the compartment allows the medicine to slide out of the compartment into the awaiting receptacle used to ingest the medicine.

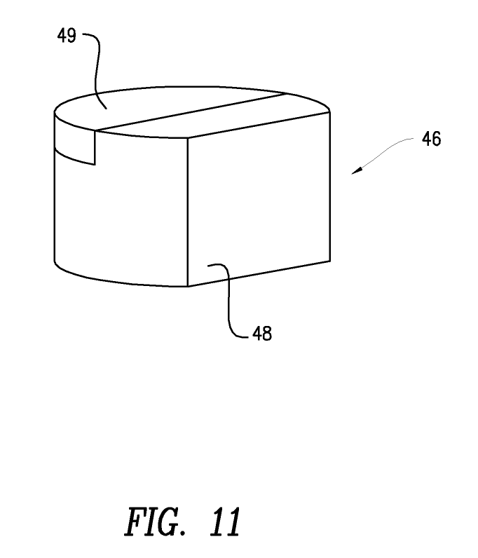

In one embodiment, a dispensing cup 46 (FIG. 11) may be used in which a generally cylindrical cup includes on flat side 48 to permit the to be positioned along side the compartment holding a dosage of medication. A lid 49 or cover for the cup made used to partially enclose the top of the cup.

In other instances, the receptacle is the awaiting cupped hand of the user. Rotating the module so that the opening of the compartments is facing upward facilitates refilling of the compartments. The pills are simply apportioned and dropped into the awaiting compartments.

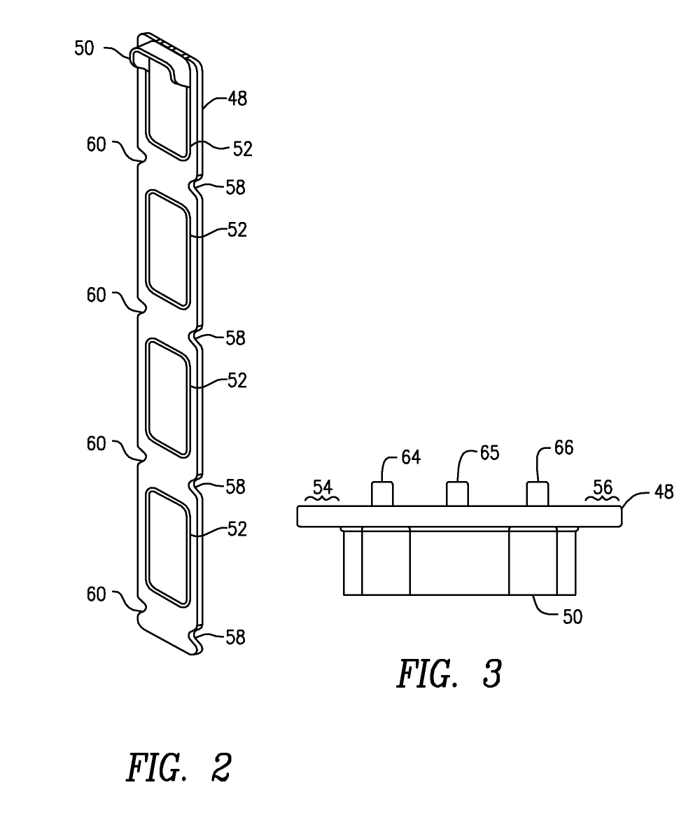

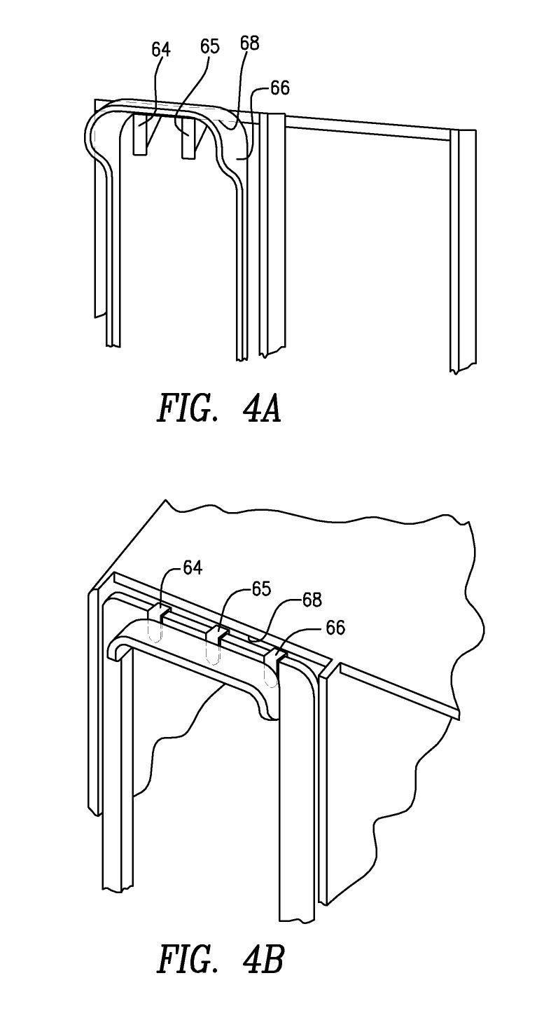

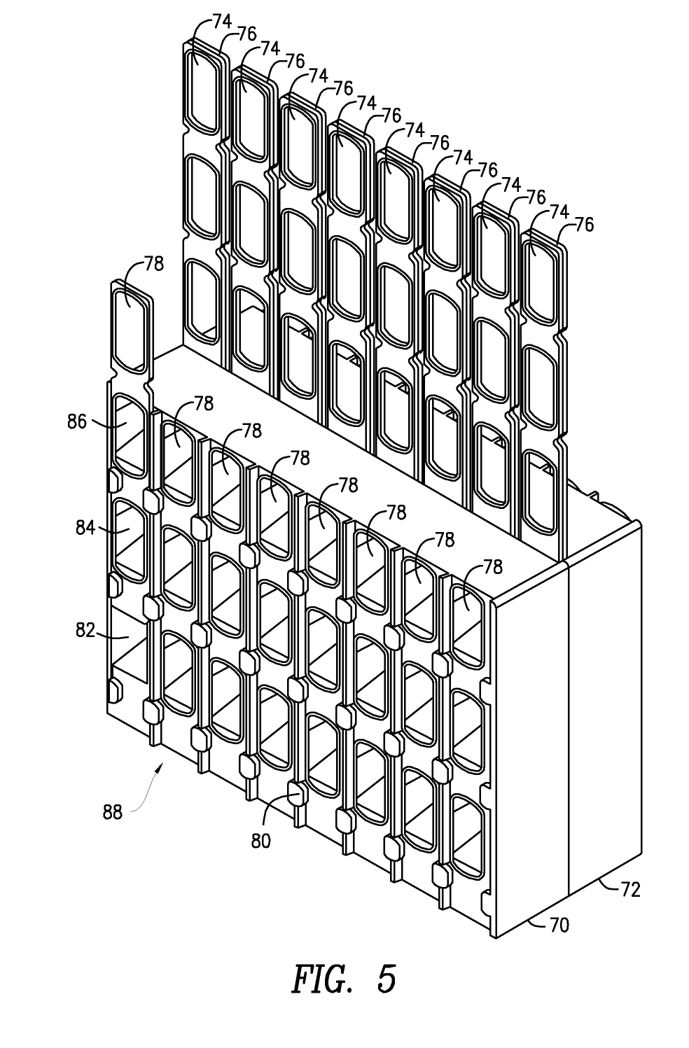

With reference to FIGS. 2 and 3, the compartment cover 48 is preferably made from injection molded transparent plastic. A finger grasp 50 protrudes out away from the forward face to facilitate grasping and movement of the compartment cover relative to the module. Each region of the compartment cover overlying a compartment includes a raised, generally rectangular ridge with rounded corners defining a frame 52 for a viewing window. Alignment of the frame over the compartment ensures alignment of the compartment cover with the module. The edges 54 and 56 of the compartment cover define the tongue that cooperates with the grooves formed by the engagement points 42 (FIG. 1) for a tongue and groove engagement and includes opposing notches 54 and 56 (FIGS. 2 and 3) spaced just below each frame 52. The notches 54 and 56 are totally covered by the engagement points when the frames 52 (FIG. 1) are aligned with the respective compartments 24 (FIG. 1). Both the notches and the frames provide a visual guide to the user for the proper alignment of the compartment cover with the module. Furthermore, the notches are aligned with nubs 62 (FIG. 1) located within the engagement points 42. The user can detect alignment of the compartment cover with respective compartments when the nubs 62 are aligned and register with the notches 58 and 60. It will be appreciated by those skilled in the art that the raised frame and window and notches with complementary nubs provide not only a visual indication of alignment with the compartments, but a touch indicator as a person with poor eyesight may use touch to feel for the registration of the notch and nubs along with feeling the relative alignment of the raised frame relative to the engagement points to determine alignment of the compartment cover with compartments in the module. On the backside of the compartment cover facing the compartments a set of teeth-like protuberances 64-66 extends away from the compartment cover opposite the finger grasp. When the compartment cover is fully inserted into the module (FIG. 4A), the protuberances 64-66 contact the inside surface 68 of the outer wall of the module and resist accidental withdraw of the compartment cover thereby prevent unintentional spillage of the medicine in the compartments. This feature is particularly useful if the medicine dispensing apparatus is used while traveling. When the user wishes to withdraw the compartment cover from the module the finger grasp is used to pull the protuberances 64-66 (FIG. 4B) out away from the insider surface 68 to allow sliding of the compartment cover along the engagement track. It will be appreciated by those skilled in the art that the relation of the finger grasp to the module allows for a user with even one hand free to grasp the compartment cover, pull away the protuberances from the module wall and allow for withdrawal of the compartment cover.

An alternate embodiment of a module configuration shown in pairs with two modules 70 and 72, illustrates how the compartment covers 74, 76 and 78 may be withdrawn from the modules 70 and 72. The modules 70 and 72 of this embodiment include eight columns of compartments 80 three rows each for a total of 24 compartments on each side. The modules 70 and 72 may include hinged or snapped engagements (not shown) to allow for securing of two modules together for transport or storage. When in use the compartment covers may be completely withdrawn from the module to signify the completion of dispensed medicine from a row. The compartment covers 74, 76 and 78 are withdrawn typically one compartment at a time. Different methodologies for dispensing the medicine at different time may be used. For example, a three-row configuration can be used to signify morning, mid-day and night from bottom to top of the column. As the compartment cover is withdrawn along the engagement track, a compartment opening is revealed to remove medicine from the compartment. The partial withdrawal of the compartment cover along with each empty compartment provides a simply visual identifier as well as touch indicators for the users to determine next compartment of medicine to be dispensed. As each column of medicine is dispensed, the user can quickly see which compartment is to be used next. The suggested sequence for retrieving medicine from the compartments when a 3×8 compartment array is used for dispensing medicine three times per day, is to start from the bottom compartment 82 on the left side and continue with each compartment 84 and then 86 in the left most column and then begin with the next column 88 in sequence. However, if the 3×8 compartment array is used for say, daily dispensing of vitamins and/or prescription medications, then the user may move from left to right along the bottom most row and sequentially move up to each successive row until the 24 days worth of compartments has been utilized. It should be noted that the type of pills used herein are not limited to medicine but may include any comestible items such as, but not limited to dietary supplements or vitamins. Naturally the sequence and distribution of the compartments may vary depending upon the users dosing regime. Furthermore, it should be note that the array of compartment used may be varied and tailored to specific dosing regimes

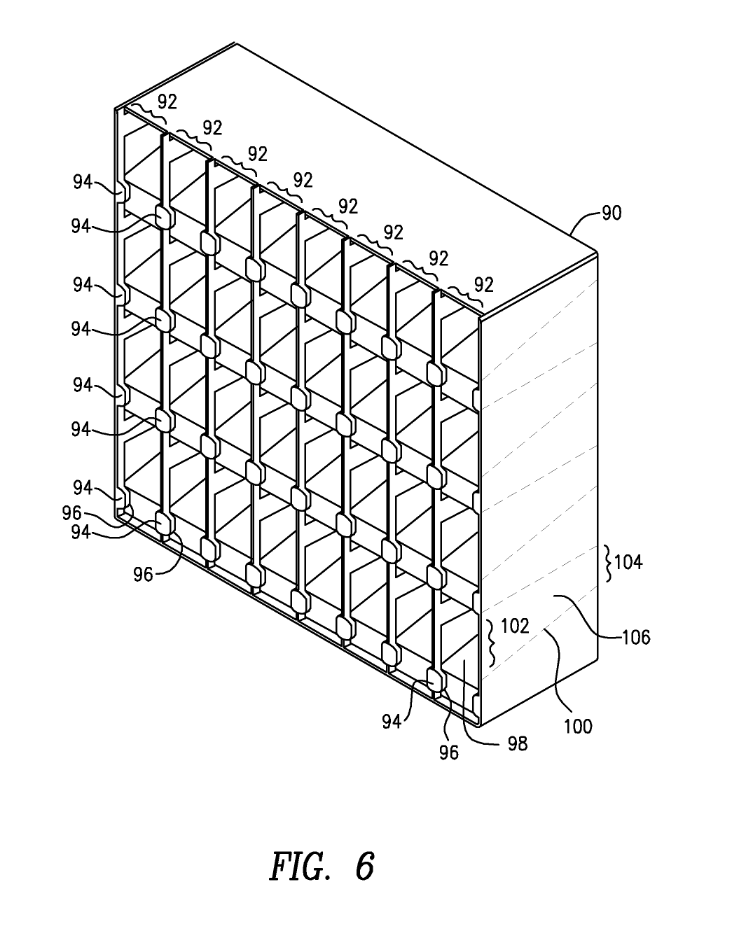

In an embodiment such as from FIG. 1, a module 90 (FIG. 6) includes an array of 4×8 compartments formed from injection-molded plastic. Although injection molding has been described other methods of manufacture such as stereo lithography or other conventional means may be used without departing from the invention. A typical configuration appropriate to the ergonomic and practical needs of a user includes a module approximately 6″ high, 6″ wide, and 1¾″ deep. There are 32 pill compartments per side (front and back), 64 compartments total. Each pill compartment will hold approximately 20 tablets in which the total number of tablets varies according to varying pill sizes (e.g., “horse” pills, aspirin tablets, etc.) for a total pill capacity of approximately 1,280 tablets. These sizes may vary according to the needs of the user. Capacity values have been determined according to industry standard measurements for capacity that are based upon quantities of 300 mg aspirin tablets that may fit into each compartment.

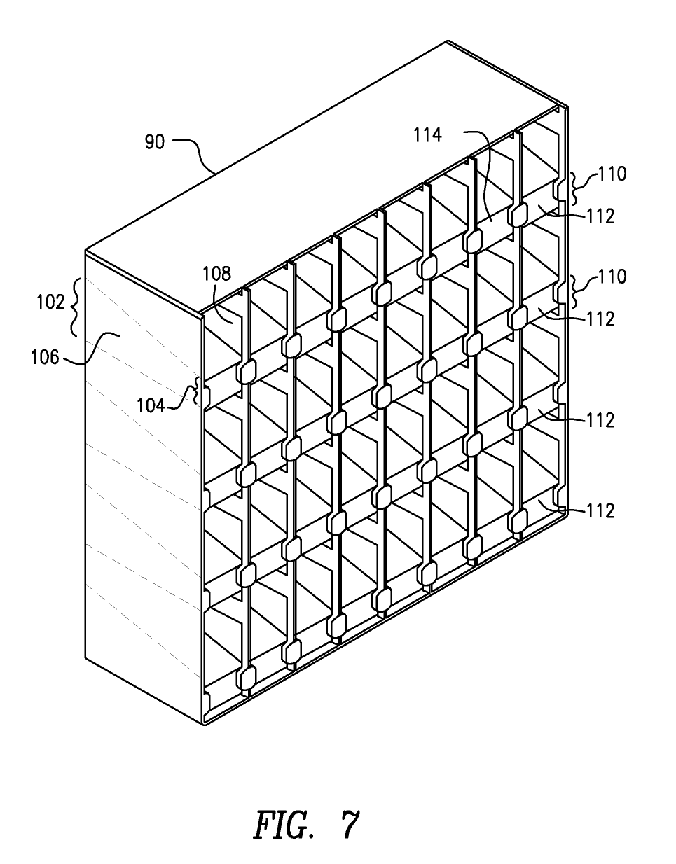

The module 90 includes an engagement track 92 for the compartment covers defined by a series of engagement points 94 overlying the compartment openings. The engagement points presently include grooves for receiving the outer edges of the compartment covers. Nubs 96 provided in the engagement points allow for locking registration of the nubs 96 with the notches 58 (FIG. 2) formed in the compartment covers. The module 90 (FIG. 6) compartments 98 include a sloped floor 100 such that the open end 102 of each compartment 98 is larger than the rear wall 104. This trapezoidal shape of the compartments sidewalls 106 allows for complementary inverted openings on the rear side of the module, thereby doubling the number of compartments within the module. Thus, a module having a 4×8 array of compartments on one side has also a 4×8 inverted array of compartments on the rear side. When one side of the module is exhausted of medicine, the user simply flips the module about a horizontal axis to begin using compartments 108 on the opposite side (FIG. 7). The rear walls 110 of the opposing sides space apart the compartment openings providing a convenient spacer 112 between each compartment in a column. This space can be pre-printed with indicia 114 such a MONDAY MORNING or WEDNESDAY NIGHT. In another embodiment, the user is provided with preprinted or blank labels (not shown) for affixing indicia that is more suitable to the user's dosing regiment. It will be appreciated by those skilled in the art that the placement of this rear walls are useful for those with sight loss to orient the module for use. In such instances raised indicia such as brail may also be used.

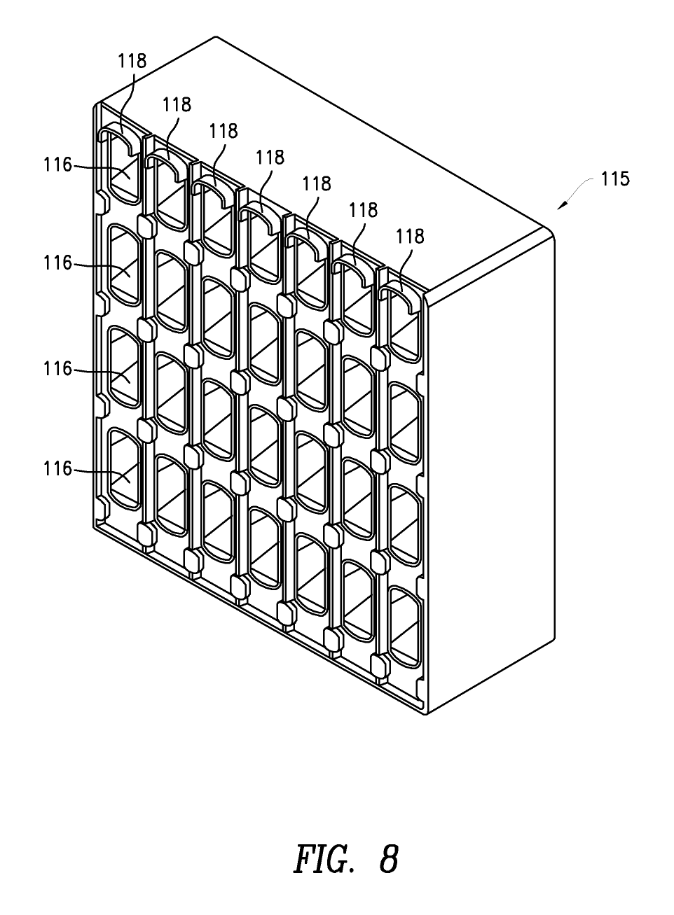

In an alternate embodiment (FIG. 8) shown in a manner similar to FIG. 1, the module 115 includes an array of 4×7 compartments 116 formed from injection-molded plastic with slidable lids 118. Although injection molding has been described other methods of manufacture such as stereo lithography or other conventional means may be used without departing from the invention. A typical configuration appropriate to the ergonomic and practical needs of a user includes a module approximately 7″ high, 7″ wide, and 1¾″ deep. There are 28 pill compartments per side (front and back), 56 compartments total. Each pill compartment will hold approximately 30 tablets in which the total number of tablets varies according to varying pill sizes (e.g., “horse” pills, aspirin tablets, etc.) for a total pill capacity of approximately 1,680 tablets. These sizes may vary according to the needs of the user.

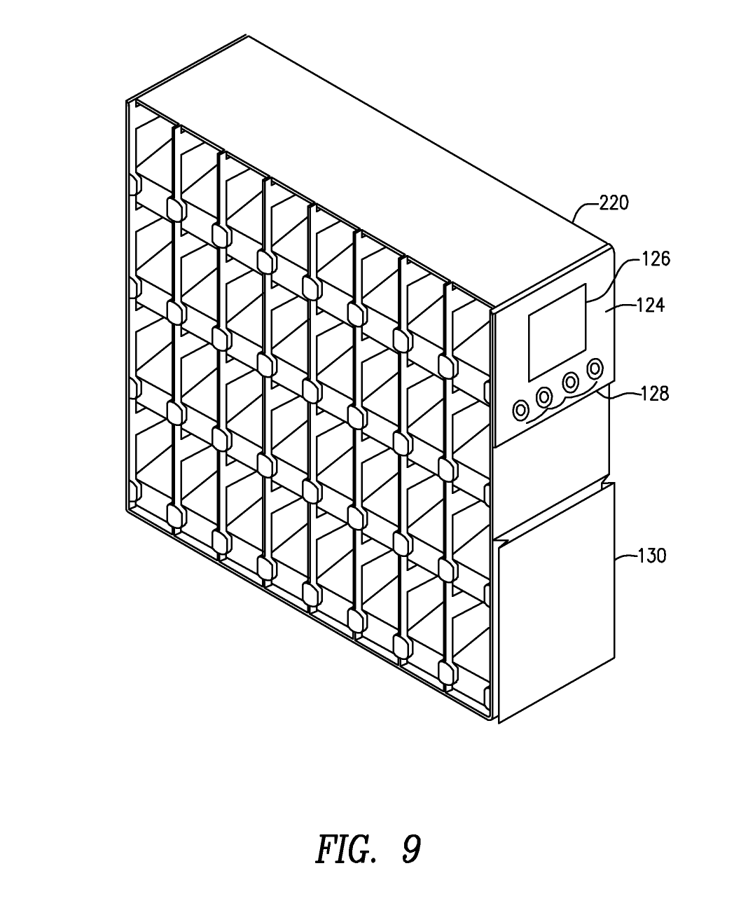

In an alternate embodiment of the present invention, a module 120 (FIG. 9) is provided with a medicine information device 124 having a user interface including a display 126 and buttons 128. The module also may have a pouch 130 for storing prescription information. With the advent of different medical specializations and alternative sources for different prescriptions, users often need help keeping track of medications and their individual sources. The day when one doctor or pharmacy met all of the medication needs of an individual have now passed. The pouch 130 provides a convenient location for placing necessary prescription information that can be used by the user when refills are required. Furthermore in view of some recent airport security screening requirements, it may be necessary to provide the copies of the prescriptions to identify the medications when traveling. It will be appreciated by those skilled in the art that a prescription compartment may be provided in forms other than a pouch and in other locations than what is shown, including, but limited to an elongated chamber within the module (not shown) or any other conventional means for storing copies of prescriptions with the module. This feature is particularly useful for those traveling or in need of a convenient storage location. Both the medicine information device 124 and pouch 130 can be attached by any conventional attachment means including, but not limited to, adhesives, slotted tongue and groove tracks or hook and loop material. The pouch and medicine information device can be used either together or individually or separately from the module.

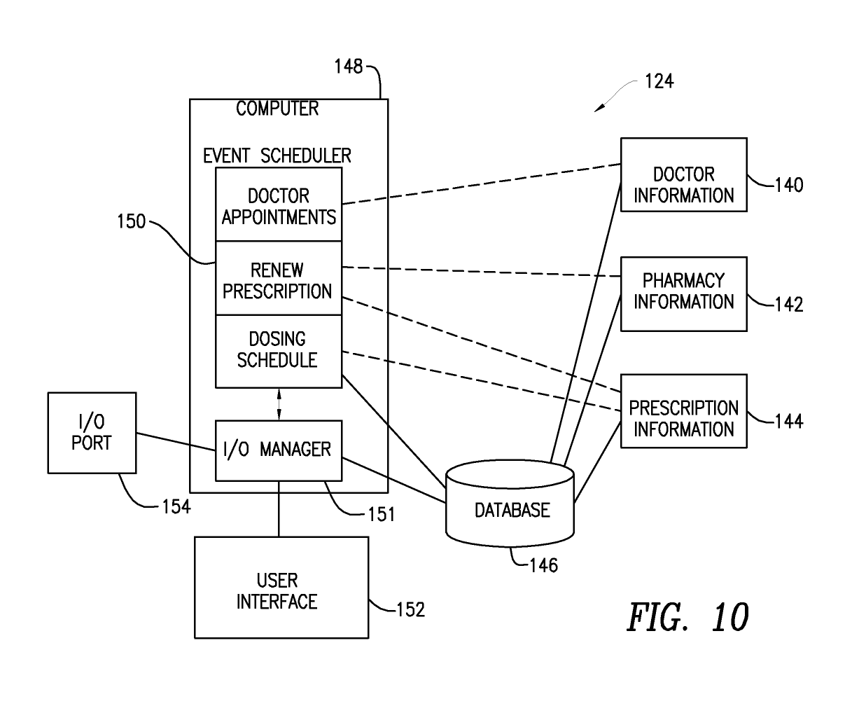

With reference to FIG. 10, the medicine information device 124 can store doctor information 140 including contact information, pharmacy contact information 142 and prescription information 144 in a database memory 146. The device includes a computer 148 having a clock and calendar program forming an event scheduler 150 that can be used via an I/O manager 151 with a user interface 152 having control buttons, a display and alarm to remind users of medication dosing times, doctor's appointments and prescription renewals. The prescription information 144 is cross-referenced with the doctor 140 and pharmacy information 142 to ensure that the appropriate contacts are associated with each medication. An optional input/output (IO) interface 154 is provided to allow for the medicine information device to connect with a personal computer (not shown) to facilitate the entry of medicine information and event schedules. An IO port of the type suitable for this purpose is a USB port.

When in use, the medicine dispensing apparatus provides a convenient ergonomic way for users to organize and refill medication dosages. The configuration of the compartment allows for one-handed dispensing of medications at appropriate intervals. The apparatus is providing with a number of indicators that can be perceived by sight and touch to determine the compartment containing the next dosage of medication. Similarly, each module includes compartment on both sides of the container thereby substantially increasing the number of dosages that may be dispensed. Modules may be combined to lock together thereby further increasing the number of dosages dispensed.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A medicine dispensing apparatus comprising:
at least one module including a plurality of compartments;
at least one side of said module having apertures to said compartments arranged in an array of rows and columns;
said module includes an engagement track extending along columns of compartments; and
a compartment cover releasably inserted into said engagement track to cover a column of compartments.

2. The apparatus of claim 1 wherein each compartment cover includes windows aligned with each of said compartments in said column.

3. The apparatus of claim 1 wherein each compartment cover is moveable along said track to incrementally uncover each compartment in said column of compartments.

4. The apparatus of claim 3 wherein each compartment cover when moved along said track includes an indicator to indicate alignment with said compartments.

5. The apparatus of claim 4 wherein the indicator is visually detected by alignment of at least one window relative to at least one compartment.

6. The apparatus of claim 4 wherein the indicator is detectable by touch to feel for the number of compartments uncovered in a column.

7. The apparatus of claim 4 wherein the indicator is detectable by a change in resistance of said cover relative to said module when pulling said cover along said track.

8. The apparatus of claim 1 wherein each compartment cover includes a latch; wherein said latch is engaged when said cover completely covers all compartments in said column of compartments.

9. The apparatus of claim 1 wherein each compartment includes an identifier region to support indicia defining said compartment.

10. The apparatus of claim 9 wherein said indicia is user defined.

11. The apparatus of claim 3 wherein said module includes a next dosage indicator defined by movement and positioning of said compartment cover along said track to reveal subsequent compartments.

12. The apparatus of claim 1 wherein:
said at least one module includes opposing sides of said module having apertures to said compartments arranged in said array of rows and columns;
where each opposing side of said module includes a set of compartments independent from the other opposing side; and
each compartment has a volume formed from a gradually tapered cross-sectional area of said compartment that extends from a greatest cross-sectional area at said opening to a least cross-sectional area most distant from said aperture.

13. A medicine dispensing apparatus comprising:
at least one module including a plurality of compartments;
opposing sides of said module having apertures to said compartments arranged in an array of rows and columns;
where each opposing side of said module includes a set of compartments independent from the other opposing side; and
each compartment has a volume formed from a gradually tapered cross-sectional area of said compartment that extends from a greatest cross-sectional area at said opening to a least cross-sectional area most distant from said aperture.

14. The apparatus of claim 13 wherein:
said at least one module includes an engagement track extending along columns of compartments; and
a compartment cover releasably inserted into said engagement track to cover a column of compartments.

15. The apparatus of claim 13 wherein each compartment when aligned to dispense medicine includes a floor surface sloped to shift medication towards said aperature.

16. The apparatus of claim 13 wherein each compartment includes opposing side walls trapezoidal in shape.

17. The apparatus of claim 17 wherein said module cooperates with a dispensing cup having a mostly cylindrical side wall, wherein a portion of said side wall is flat to a flat lip to place against a side of the module under a compartment aperture to receive medications therefrom.

18. The apparatus of claim 13 wherein:
said columns and rows form arrays selected from the group consisting of a 7×4 array and an 8×4 array;
modules of the same array size may be interlocked together; and
said compartments are sized to accommodate at least 30 aspirin tablets of 300 mg each.

19. A medicine dispensing apparatus comprising:
at least one module having a plurality of medication compartments;
a compartment for storing prescription information;
a medicine information device operating under the control of software to provide:
reminders of medication dosing times;
reminders of doctor's appointments;
reminders of prescription renewals; and
a cross-indexed reference tying medication and prescription information to an issuing doctor and pharmacy;
whereby said medicine dispensing apparatus provides a convenient way for users to organize, dispense and refill medication dosages.

20. The apparatus of claim 19 including:
opposing sides of said module having apertures to said compartments arranged in said array of rows and columns;
where each opposing side of said module includes a set of compartments independent from the other opposing side;
each compartment has a volume formed from a gradually tapered cross-sectional area of said compartment that extends from a greatest cross-sectional area at said opening to a least cross-sectional area most distant from said aperture;
said module includes an engagement track extending along columns of compartments;
a compartment cover releasably inserted into said engagement track to cover a column of compartments
